(19) United States
(12) Patent Application Publication
(10) Pub. No.: US 2008/0175960 A1
(43) Pub. Date: Jul. 24, 2008

(54) Coating for adhering food substrate particulates

(75) Inventor: Joseph A. Formanek, Bolingbrook, IL (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Griffith Laboratories International, Inc., Alsip, IL (US)

(21) Appl. No.: 11/655,519

(22) Filed: Jan. 18, 2007

(51) Int. Cl. A23L 1/216

(52) U.S. Cl. 426/96

(57) ABSTRACT

A unique coated food substrate carrying adherent particulates including a food substrate and a heat set adherent coating on the substrate, the adherent coating including an alginate salt and a source of calcium ions, and particulates larger than 16 mesh and less than ½ inch in cross-section bound to the substrate by the adherent coating; and the method of making such unique coated food substitutes.

### BACKGROUND OF THE INVENTION

This invention relates generally to compositions and methods for adhering particulates to food substrates and particularly, to coatings and methods for adhering particulates such as spices, seeds, nuts, dehydrated vegetables, bread crumbs, and extruded snacks that are deep fried after extrusion and that are larger than 16 mesh and less than ½ inch in cross-section to food substrates in such a way that the particulates are retained even when the coated substrate is subjected to retorting.

In preparing foods it is often necessary or desirable to adhere particulates to the substrate in such a way that the particulates are retained even when the coated substrate is subjected to retorting. Such particulates are typically used to add visual excitement to the product and to add flavor and texture. Food substrates for which this is desirable include fish, seafood, poultry, meat, vegetables, baked goods and snacks, and fried snacks (e.g., chips and corn curls).

The particulates that may be used in such applications include spices, herbs, seeds, nuts, dehydrated vegetables, bread crumbs, and extruded snacks that are deep fried after extrusion that are larger than 16 mesh and less than ½ inch in cross-section. Unfortunately, currently there is no way to satisfactorily adhere such particulates to food substrates in a way that insures that they will remain visible and reliably adhere when the substrate is subjected to retorting during preparation or when it is heated-prior to being served.

It is therefore an object of the present invention to provide compositions arid methods for securely adhering particulates to food substrates in such a way that the particulates are retained even when the coated substrate is subjected to retorting.

It is a further object of the present invention to provide compositions and methods for adhering particulates to food substrates without creating undesirable organoleptic properties at the surface of the substrates.

Yet another object of the invention is to provide compositions and methods for securely adhering particulates to food substrates without obscuring the color or other visual characteristics of the substrate or the particulates.

These and other objects of the present invention will be apparent from the description that follows.

### SUMMARY OF THE INVENTION

The present invention comprises an adherent composition and a method for binding particulates to food substrates in such a way that the particulates are retained even when the coated substrate is subjected to retorting. The adherent composition comprises a combination of an alginate salt and a source of calcium ions.

The particulates may be bound to the substrate in one of three ways: a) by dispersing the particulates in the adherent composition and then applying the adherent composition to the substrate (e.g., by a tumbling application); b) by applying the adherent composition to the substrate and then applying the particulates; or c) by applying the particulates to the substrate and then coating with the adherent composition. Among these application techniques, the first is preferred. Also, two or more of these techniques may be used with a single substrate. For example, a first application of particulates may be adhered to a substrate by dispersing it in the adherent composition and coating the substrate and a second application of particulates may be adhered by applying the second particulates over the already coated substrate.

After the adherent coating and particulates are applied, the coated substrate is heat-set. This may be done for example in an oven or a fryer. It may also be done by microwaving. The heat-set coated substrate may then be fully baked and served, it may be refrigerated for storage and then baked or otherwise reheated and served, or it may be frozen for storage, and then baked or otherwise reheated, and served.

The present invention also includes a product comprising a food substrate with a set adherent coating composition on the substrate and particulates embedded in or bound to the coating.

### DETAILED DESCRIPTION OF A PREFERRED EMBODIMENT

The adherent composition of the present invention produces a continuous coating on food substrates that functions as a vehicle to adhere particulates such as spices, seeds, nuts, dehydrated vegetables, bread crumbs, extruded snacks that are deep fried after extrusion, etc. that are larger than 16 mesh and less than ½ inch in cross-section so that the particulates are retained even when the coated substrate is subjected to retorting. The coating is substantially transparent or invisible in the sense that a person eating the coated substrate generally will not be able to tell that there is a coating on it either visually or organoleptically (e.g., by way of tackiness or tooth pack when he bites down on the coated substrate).

An adherent composition/particulate combination in accordance with the present invention may be prepared by adding an appropriate level of particulates to the coating composition and mixing until the particulates are fully dispersed. When the resulting composition is to be applied, for example, by dipping, an appropriate substrate may be dipped in the composition while the particulates remain dispersed therein.

The adherent composition will comprise a source of alginate (preferably sodium alginate), a source of calcium ions and optimally carrageenan. The level of alginate should be chosen to deliver about 0.15 to 0.25 percent by weight of alginate based on the weight of the substrate. Preferably the alginate level will be chosen to deliver about 0.15 percent by weight alginate based on the weight of the substrate. The level of alginate in the adherent composition will therefore depend on the application parameters.

The level of calcium ions delivered should be about 0.1 to 1.0 percent by weight based on the weight of the substrate. Preferably the delivered calcium ion level will be about 0.25 percent by weight. As in the case of the alginate, the level of sodium ions in the adherent coating composition will therefore depend on the application parameters. Preferably, the calcium ion source will be a food grade water soluble calcium salt. Calcium lactate is particularly preferred because it has been found to moderate or slow the rate of set to permit optimal placement and adherence of the particulates.

It is also preferred, particularly in tumbling (or marination) applications, to include carrageenan. The level of carrageenan delivered, based on the weight of the substrate, should be about 0 to 1 percent by weight, preferably about 0.1 to 0.7 percent by weight and most preferably about 0.2 to 0.5 percent by weight. Locust bean gum can be substituted for some or all of the carageenan but may produce less adherence.

Finally, the pH of the adherent coating composition preferably will be at least pH 5.5. and most preferably will be in the range of about pH 5.5 to pH 10.0.

The particulates can be applied at any desirable level up to a level that will substantially cover the entire exposed surface of the substrate.

The adherent coating composition typically will be applied as an aqueous solution. Preferably at least some of the particulates to be adhered to the substrate will be included in the powdered ingredients used to make up the adherent coating solution since this has been found to minimize clumping and fisheye formation.

The particulates may be spices, herbs, seeds, nuts, dehydrated vegetables, bread crumbs, extruded snacks that are deep fried after extrusion, etc. that are larger than 16 mesh and less than ½ inch in cross-section. Preferably the particulates will be about 1/16 to ¼ inch in cross-section.

The substrates that may be used in the practice of the present invention include fish, seafood, poultry, meat, vegetables, baked goods and snacks, and fried snacks. Among these, currently the most preferred food substrates are fresh chicken breasts. If the substrate is fish, seafood, poultry or meat it may be fresh, frozen or pre-cooked at the time of the application of the adherent coating composition.

### EXAMPLES

The present invention is illustrated, in part, by the following examples. Further embodiments within the spirit and scope of this invention are described in the specification above and in the claims which follow below.

### 1. Tumble Application.

In this example, the substrate used was fresh skinless boneless chicken breasts. An adherent coating composition was prepared from the following ingredients:

| | Level |
|---|---|
| Ingredient | (Percentage by Weight) |
| Calcium Lactate | 75 |
| K Carrageenan | 10.5 |
| Soybean Oil | 5.25 |
| Calcium Silicate | 5.0 |
| Sodium Alginate | 4.25 |

The chicken substrate was tumbled at about 25% by weight of adherent composition to substrate for 30 minutes under vacuum at a temperature of about 32-40° F. to apply about 1.4 lbs. of adherent composition per 100 lbs. (about 1.4% delivered) to the chicken substrate. The water present in the adherent composition delivered about 10% of the weight of the coated product. The adherent coated substrate was then tumbled for 10 minutes under vacuum at a temperature of about 32-40° F. in particulate coating compositions comprising parsley and black pepper (“seasoning blend”) alone and in combination with dried bread crumbs. All of the particulates were larger than 16 mesh and less than ½ inch in cross-section. The total pick-up with the dried bread crumbs was about 15.1% by weight to provide one pound of particulate and adherent composition per 100 lbs. of chicken substrate and functional base.

The substrates bearing the adherent composition and particulate coating were then heat-set by baking in a jet stream oven.

An alternative heat setting by frying was performed by parfrying in a deep fryer at: 370° F. for about 30 seconds or fully frying in a deep fryer at 350° F. for about 10 minutes (until an internal temperature of 70° C. was reached).

The seasoning blend coated samples performed very well with strong adherence, while the seasoning blend/crumb coated samples did not do as well but performed at least as satisfactorily as a convention application system.

### 2. Dip and Marinade Applications.

In this example, the substrate again was skinless boneless chicken breasts. Some of the chicken breasts were marinated for about a half hour in a flavoring marinade that did not contain the adherent coating ingredients (alginate, lactate, carageenan), after which the adherent was applied in a dip process where the dip composition included, on a percentage by weight basis, 0.1 sodium alginate, 5.0% calcium lactate and 1.0% carageenan. A particulate coating as in Example 1 was then applied (with like pick-up) and the final coated product heat set, also as in Example 1. The other chicken breasts were subjected to marinades containing adherent as follows:

MARINADES

| | Sodium | Sodium | Kappa | |
|---|---|---|---|---|
| Marinade | Alginate | Lactate | Carrageenan | Silicate |
| A | 0.04% | 0.7% | 0.1% | 0.05% |
| B | 0.25% | 1.2% | 0.3% | 0.25% |

Particulates were applied and the product heat set in a jet stream oven as described above in connection with marinated/dip coated chicken breasts. The resulting marinated/dipped, and marinated products all performed well with regard to particulate retention, although Marinade B was preferred with regard to particulates at the larger end of the range.

### 3. Raw Fish.

In this example the substrate was raw fish, the coatings and parameters of Example 2 were used, and the coated raw fish was frozen after heat setting. The results were substantially the same as in Example 2.

### 4. Chicken Strips—Particulate Adherence.

In this example, an adherent composition as in Example 1 in the for of a marinade was applied to chicken strips via dipping. After the dip, the particulates listed below (all larger than 16 mesh and less than ½ inch in cross-section) were applied and the coated substrate parfried @ 375F/1 min, and then frozen. Later, the frozen product was baked @375F/10 min or fried @ 375F for 3 min. Particulate adherence at 3% coating pick-up level was found to be as follows:

| Description | Adherence quality |
|---|---|
| Whole anise | Good |
| Sesame Seed | Very good |
| Minced onion | Fair but acceptable |
| 10M BP | Very good |
| 6M BP | Fair but acceptable |
| Whole fennel | Good |
| Red bell pepper 8 + 40 | Fair |
| 40M Crushed Red bell pepper | Good |
| Chopped onion | Good |
| Red bell pepper′/4″ | Fair but acceptable |
| Carrot pieces | Good |
| Kibbled mushrooms | Good |
| Sliced onions | Good |
| Crosscut celery | Good |

### 5. Sliced Potato Testing

An adherent batter was prepared from the following ingredients per 100 g of substrate:

| | |
|---|---|
| 1.0% | Salt |
| 0.15% | TCP |
| 0.6% | Calcium lactate |
| 0.05% | Soybean oil |
| 0.35% | Phosphate |
| 0.10% | Calcium chloride |
| 0.10% | K carrageenan |
| 0.04% | Sodium alginate |
| 0.05% | Calcium silicate |

Sliced potatoes were blanched and cooled and then combined with the adherent batter containing 23.3 percent by weight black pepper and 11.6% parsley flakes.

Trial #1: Used 4.3 g marinade+10 g water per 100 g potatoes; tumbled for 5 min; parfried 30 sec @ 375F, then frozen; reconstituted in oven @ 375F.
Results: fair but acceptable adhesion—some loss in fryer.

Trial #2: Increased carrageenan and alginate usage—added 20 g/ea to 100 g marinade, and used same process.
Results: markedly improved adhesion

Tested Trial #2 product by freezing fully cooked product followed by microwave reconstitution: also good adhesion.

### 6. Shrimp/Scallops Substrate

The testing scheme of Example 5 was used with shrimp and scallops which were tumbled for 15 minutes, and then parfried, frozen, and oven reconstituted. This was followed by an additional freeze, then microwave reconstitution.

The results were as follows:

Trial #1: W/o additional carrageenan/alginate
Results: Fair but acceptable adhesion for scallops, better for shrimp.

Trial #2: w/increased carrageenan/alginate—scallops/added 20 g/ea to 100 g marinade; shrimp/added 10 g/ea to 100 g marinade.
Results—very good adhesion for both, in both oven and microwave.

While the present invention is described above in connection with preferred or illustrative embodiments, these embodiments are not intended to be exhaustive or limiting of the invention. Rather, the invention is intended to cover all alternatives, modifications and equivalents included within its spirit and scope, as defined by the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A coated food substrate carrying adherent particulates comprising:
a food substrate,
a heat set adherent coating on the substrate,
the adherent coating including an alginate salt and a source of calcium ions; and
particulates bound to the substrate by the adherent coating, the particulates being larger than 16 mesh and less than ½ inch in cross-section.

2. The coated food substrate of claim 1 in which the alginate salt is sodium alginate.

3. The coated food substrate of claim 1 in which the source of the calcium ions source is a water soluble calcium salt.

4. The coated food substrate of claim 3 in which the water soluble calcium salt is calcium lactate.

5. The coated food substrate of claim 1 in which the adherent coating includes carrageenan or locust bean gum.

6. The coated food substrate of claim 1 in which the level of alginate salt is chosen to deliver about 0.15 to 0.25 percent by weight of alginate based on the weight of the substrate.

7. The coated food substrate of claim 1 in which the level of alginate salt is chosen to deliver about 0.15 percent by weight of alginate based on the weight of the substrate.

8. The coated food substrate of claim 1 in which the level of the source of calcium ions is chosen to deliver about 0.1 to 1.0 percent by weight calcium based on the weight of substrate.

9. The coated food substrate of claim 1 in which the level of the source of calcium ions is chosen to deliver about 0.25 percent by weight calcium based on the weight of substrate.

10. The coated food substrate of claim 1 in which the particulates are present at a level up to that which will substantially cover the entire exposed coated surface of the substrate.

11. The coated food substrate of claim 1 in which the particulates are chosen from the group consisting of spices, herbs, seeds, nuts, dehydrated vegetables, bread crumbs, extruded snacks that are deep fried after extrusion.

12. The coated food substrate of claim 1 in which the particulates are about 1/16 to ¼ inch in cross section.

13. The coated food substrate of claim 1 in which the substrate is chosen from the group consisting of fish, seafood, poultry, meat, vegetables, baked goods and snacks, and fried snacks.

14. The coated food substrate of claim 15 in which the substrate comprises fresh chicken breasts.

15. A method of preparing a coated substrate with an adherent layer of particulates about 16 mesh to ½ inch mesh in cross-section comprising:
providing a food substrate,
applying an adherent composition containing an alginate salt and a source of calcium ions to the substrate,
applying particulates sized about 16 mesh to ½ inch mesh in cross-section to the substrate; and
heat setting the adherent coating.

16. The method of claim 15 in which the alginate salt is sodium alginate.

17. The method of claim 15 in which the source of calcium ions is calcium lactate.

18. The method of claim 15 in which the coated substrate is heat set by a step chosen from the group consisting of baking in an oven, frying, and microwaving.

19. The method of claim 15 in which the substrate before coating is raw or parbaked and it is fully baked following the heat setting step.

20. The method of claim 15 in which the substrate is frozen following the heat set step.

21. The method of claim 15 in which the particulates are applied at a level up to that which will substantially cover the entire exposed coated surface of the substrate.

22. The method of claim 15 in which the particulates are chosen from the group consisting of spices, herbs, seeds, nuts, dehydrated vegetables, bread crumbs, extruded snacks that are deep fried after extrusion.

23. The method of claim 15 in which the substrate is chosen from the group consisting of fish, seafood, poultry, meat, vegetables, baked goods and snacks, and fried snacks.

24. The method of claim 15 in which the particulates are bound to the substrate by dispersing the particulates in the adherent composition and then applying the adherent composition to the substrate.

25. The method of claim 15 in which the particulates are bound to the substrate by applying the particulates to the substrate and then coating with the adherent composition:

26. The method of claim 15 in which a second layer of particulates is adhered by applying the second layer of particulates over the already coated substrate.

27. The method of claim 15 in which the pH of the adherent coating composition is at least 5.5.

28. The method of claim 15 in which the pH of the adherent coating composition is about 5.5 to 10.0.

29. The method of claim 15 in which the substrate is fish, seafood, poultry or meat that is frozen at the time of the application of the adherent coating composition.

30. The method of claim 15 in which the substrate is fish, seafood, poultry or meat that is fresh at the time of the application of the adherent composition.

31. The method of claim 15 in which the substrate is fish, seafood, poultry or meat that is pre-cooked at the time of the application of the adherent composition.

32. The method of claim 15 in which, the level of alginate salt is chosen to deliver about 0.15 to 0.25 percent by weight of alginate based on the weight of the substrate.

33. The method of claim 15 in which, the level of the source of calcium ions is chosen to deliver about 0.1 to 1.0 percent by weight calcium based on the weight of substrate.
